(19) United States
(12) Patent Application Publication
(10) Pub. No.: US 2026/0271899 A1
(43) Pub. Date: Sep. 17, 2026

(54) REEL SEAT AND FISHING ROD

(71) Applicant: GLOBERIDE, Inc., Tokyo (JP)

(72) Inventor: Takumi ICHIMURA, Tokyo (JP)

(73) Assignee: GLOBERIDE, Inc., Tokyo (JP)

(21) Appl. No.: 19/447,193

(22) Filed: Jan. 13, 2026

(30) Foreign Application Priority Data
Mar. 11, 2025 (JP) 2025-038757

(51) Int. Cl. A01K 87/06

(52) U.S. Cl. CPC A01K 87/06

(57) ABSTRACT

A reel seat comprises a reel seat body having a placement portion on which mounting leg portions of a reel are placed; and a fixed hood and a movable hood each of which has a tubular shape and is provided so as to face the reel seat body. At least one of the fixed hood or the movable hood is provided with an extending portion extending while reducing in diameter toward the other. The extending portion is configured to be provided with a partial notch portion.

### CROSS-REFERENCE TO RELATED APPLICATION

This application claims priority under 35 U.S.C. § 119 to Japanese Patent Application No. 2025-038757 filed on Mar. 11, 2025 in the Japanese Patent Office, the entire contents of each hereby incorporated by reference.

### BACKGROUND OF THE INVENTION

### 1. Technical Field

The present invention relates to a reel seat and a fishing rod.

### 2. Description of the Related Art

Conventionally, a reel seat including a pair of hoods into which mounting leg portions of a reel are inserted is known (see, for example, JP 2007-6801 A). In this reel seat, a flat locking surface is provided on a side surface of at least one hood of the pair of hoods. According to this reel seat, when gripping the fishing rod, the fingertips are easily caught on the locking surface, and stability of the hand in gripping can be obtained. Accordingly, the holding performance is improved, and an operability in fishing is improved.

On the other hand, a technique disclosed in JP H9-298992 A is known as a reel seat that improves hand feel when gripped. In this reel seat, an outer surface of a movable hood is formed in a tapered shape that has a diameter decreasing toward a fixed hood side.

Incidentally, it is known to use a fishing rod using a metal reel seat in fishing that requires a power fight. The metal reel seat is configured by combining a reel seat body and a hood which are individually formed of metal materials. For this reason, a step is likely to be formed between the reel seat body and the hood, and there has been a demand for reducing hand feel when gripped.

The present invention has been made in order to solve the above problems, and an object of the present invention is to provide a reel seat and a fishing rod which offer a favorable hand feel when gripped and are excellent in operability in fishing.

### SUMMARY OF THE INVENTION

In order to solve the above problems, a reel seat according to the present invention comprises a reel seat body having a placement portion on which a mounting leg portion of a reel is placed; and a fixed hood and a movable hood each of which has a tubular shape and is provided so as to face the reel seat body. At least one of the fixed hood or the movable hood is formed with an extending portion extending while reducing in diameter toward the other. The extending portion comprises a notch portion that is partially notched.

In the present invention, since one hood comprises the extending portion extending while reducing in diameter toward the other hood, the step formed between the reel seat body and the hood is reduced as much as possible, and the hand feel when gripped is improved. In addition, since the extending portion is partially notched due to the notch portion, it is possible to reduce the weight while providing the extending portion in a necessary portion. For example, by providing the notch portion in the portion corresponding to the placement portion, it is possible to suitably prevent the mounting leg portion of the reel from interfering with the extending portion when the reel is attached or detached. In addition, since the facing surfaces of the fixed hood and the movable hood do not entirely come into contact with each other due to the presence of the extending portion, workability at the time of mounting the reel is improved.

In addition, the reel seat body, the fixed hood, and the movable hood are preferably made of metal. In this configuration, in a case where the reel seat body and the hood which are made of metal are combined, a step that is likely to be formed between the reel seat body and the hood is reduced as much as possible, and the hand feel when gripped is improved.

In addition, in the extending portion, a portion corresponding to the placement portion is preferably notched due to the notch portion. In this configuration, it is possible to suitably prevent the mounting leg portion of the reel from interfering with the extending portion when the reel is attached or detached and after the reel is mounted. Therefore, smooth attachment and detachment of the reel can be realized, and damage to the mounting leg portion and the hood can be prevented.

In addition, it is preferable that a circumferential end of the extending portion notched due to the notch portion is disposed at a position away from the placement portion when viewed in an axial direction of the reel seat body. In this configuration, it is possible to reliably avoid the mounting leg portion of the reel from interfering with the extending portion when the reel is attached or detached. Therefore, smooth attachment and detachment of the reel can be realized.

In addition, it is preferable that the reel seat body comprises a male screw portion, and the reel seat comprises a nut member for preventing loosening that is screwed to the male screw portion and tightened toward the movable hood. In this configuration, by tightening the nut member, the movable hood can be prevented from moving in a loosening direction, so that the reel can be firmly fixed. Therefore, fishing operability is improved.

In order to solve the above problems, a fishing rod of the present invention comprises the reel seat. In the present invention, since one hood of the reel seat comprises the extending portion extending while reducing in diameter toward the other hood, the step formed between the reel seat body and the hood is reduced as much as possible, and the hand feel when gripped is improved.

In addition, since the extending portion is partially notched due to the notch portion, it is possible to reduce the weight while providing the extending portion in a necessary portion. For example, by providing the notch portion in the portion corresponding to the placement portion, it is possible to suitably prevent the mounting leg portion of the reel from interfering with the extending portion when the reel is attached or detached.

In addition, in a case where the reel seat body and the hood which are made of metal are combined, a step that is likely to be formed between the reel seat body and the hood is reduced as much as possible, and the hand feel when being gripped is improved.

According to the reel seat and the fishing rod of the present invention, the hand feel when gripped is favorable, and the operability in fishing is excellent.

### BRIEF DESCRIPTION OF THE DRAWINGS

FIG. 1 is a side view illustrating a fishing rod to which a reel seat according to a first embodiment of the present invention is applied;

FIG. 2 is a side view illustrating the reel seat as well;

FIG. 3 is a plan view illustrating the reel seat as well;

FIGS. 4A and 4B are views illustrating a fixed hood, in which FIG. 4A is an enlarged side view and FIG. 4B is an enlarged plan view;

FIGS. 5A and 5B are schematic cross-sectional views of the fixed hood, in which FIG. 5A is a partially omitted schematic cross-sectional view taken along line V-V in FIG. 4A, and FIG. 5B is a partially omitted schematic cross-sectional view taken along line V1-V1 in FIG. 4A;

FIG. 6 is a side view illustrating a state where a reel is mounted on the reel seat;

FIG. 7 is a side view illustrating a state where a movable hood has moved to a fixed hood side;

FIGS. 8A and 8B are views illustrating a fixed hood side of a reel seat according to a second embodiment, in which FIG. 8A is an enlarged side view and FIG. 8B is an enlarged side view in an exploded state;

FIG. 9 is a side view illustrating a reel seat according to a third embodiment; and

FIG. 10 is an enlarged side view illustrating a fixed hood side of a reel seat according to a fourth embodiment.

### DETAILED DESCRIPTION

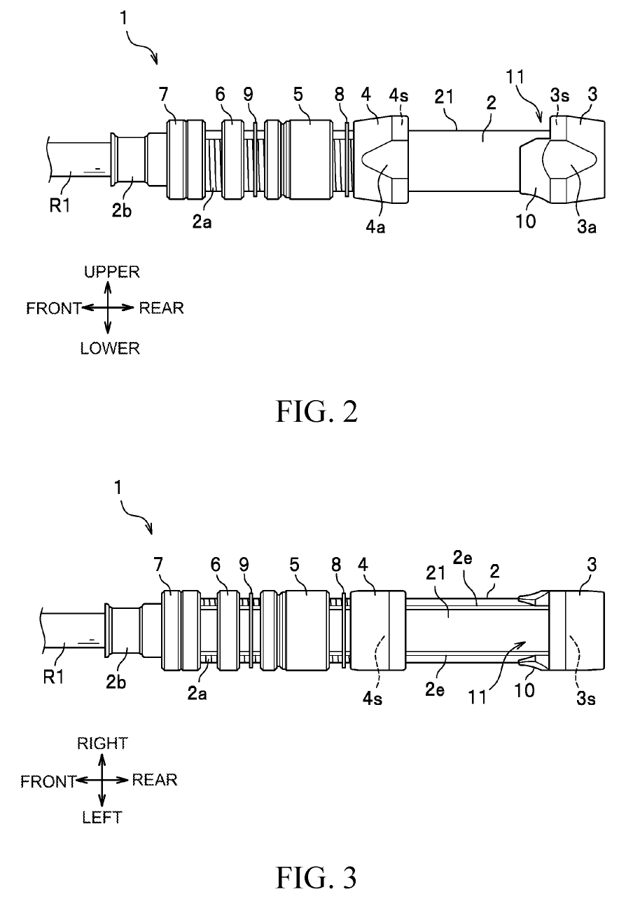

Hereinafter, a reel seat and a fishing rod according to an embodiment will be described in detail with reference to the drawings. In the following description, terms “front and rear” and “up and down” are based on directions illustrated in FIG. 2, and terms “front and rear” and “left and right” are based on directions illustrated in FIG. 3. Note that although the reel seat according to the embodiment is exemplified as a reel seat for a double-bearing reel (hereinafter, simply referred to as a “reel”), it is not intended to limit the form of the reel. In addition, in the description of the drawings, the same elements are denoted by the same reference sign, and a duplicate description is appropriately omitted.

### First Embodiment

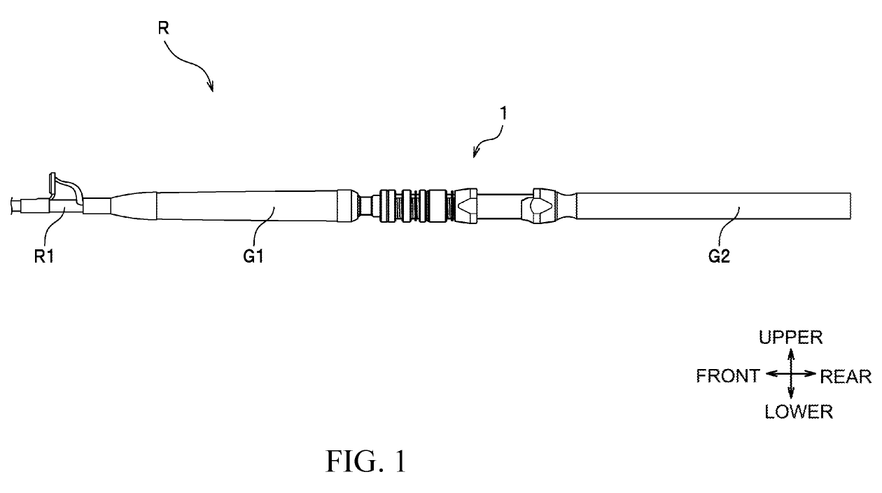

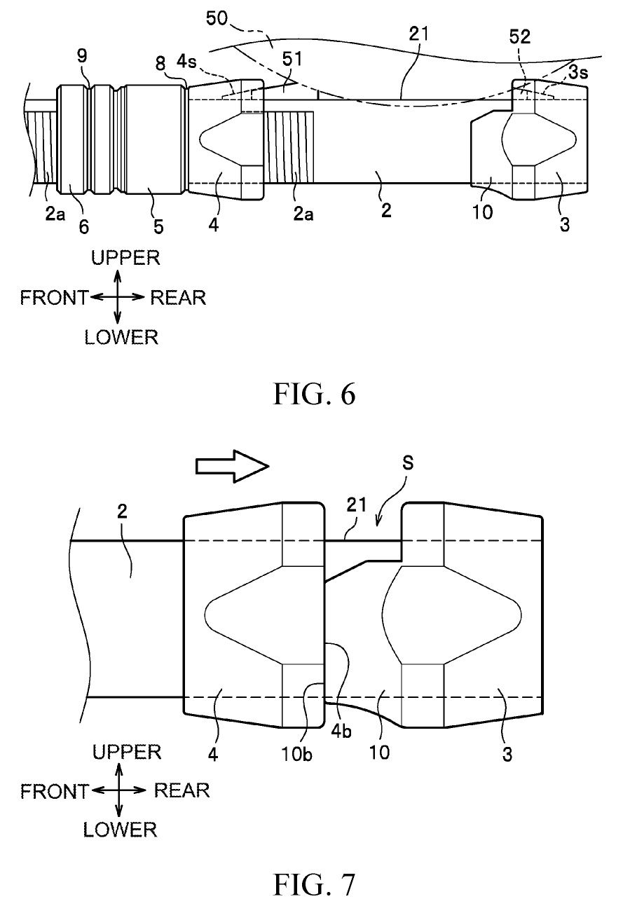

As illustrated in FIG. 1, a fishing rod R comprises a reel seat 1. The reel seat 1 is a member for fixing a reel 50 (see FIG. 6, the same applies hereinafter) to the fishing rod R, and front and rear mounting leg portions 51 and 52 (see FIG. 6, the same applies hereinafter) of the reel 50 are attached to the reel seat 1. The fishing rod R comprises a cylindrical rod body R1, a front grip G1, a rear grip G2, and the like. The rod body R1 comprises a single rod member. Note that the rod body R1 may be configured by joining a plurality of rod members such as a middle rod and a tip rod. In this case, the joining may be made by a telescopic type, an ordinarily jointed type, an inversely jointed type, a socket-and-spigot jointed type, or any other known jointing type.

As illustrated in FIGS. 2 and 3, the reel seat 1 comprises a reel seat body 2, a fixed hood 3, a movable hood 4, an operation member 5, a nut member 6, and a fixing member 7. Each of these members is formed of a metal material. Then, the reel seat 1 is configured by assembling each member to the reel seat body 2. Note that the members may be formed of the same metal material, or may be formed of different metal materials. Furthermore, a resin material or the like may be used as a part of each member.

In the reel seat 1, washers 8 and 9 are disposed between the movable hood 4 and the operation member 5 and between the operation member 5 and the nut member 6. Note that the reel seat 1 is not limited to one formed by combining metal members, and may be entirely or at least partially formed of a material other than metal, for example, a material made of a synthetic resin or the like.

The reel seat body 2 is a portion gripped by the fingers of an angler and is formed in a substantially hollow cylinder. The rod body R1 is inserted and fixed to the reel seat body 2 from the front side via a connection component (or a joint component) 2b or the like. As illustrated in FIG. 3, a pair of left and right step portions 2e are formed in the upper portion of the reel seat body 2 over a front-rear direction. The step portion 2e functions as a guide groove for guiding the movable hood 4 and the operation member 5 so as to be movable in the front-rear direction and non-rotatable in a circumferential direction with respect to the reel seat body 2. An engaging portion (not illustrated) engageable with the step portion 2e is formed in the movable hood 4 and the operation member 5.

A placement portion 21 on which the mounting leg portions 51 and 52 of the reel 50 are placed is formed in an upper portion on a rear portion side of the reel seat body 2. As illustrated in FIGS. 2 and 3, a male screw portion 2a to which the operation member 5 and the nut member 6 are screwed is formed in a central portion from a front portion side of the reel seat body 2. As illustrated in FIG. 2, the male screw portion 2a is disposed in a portion excluding the upper portion of the reel seat body 2. Note that the placement portion 21 may be formed in a planar shape.

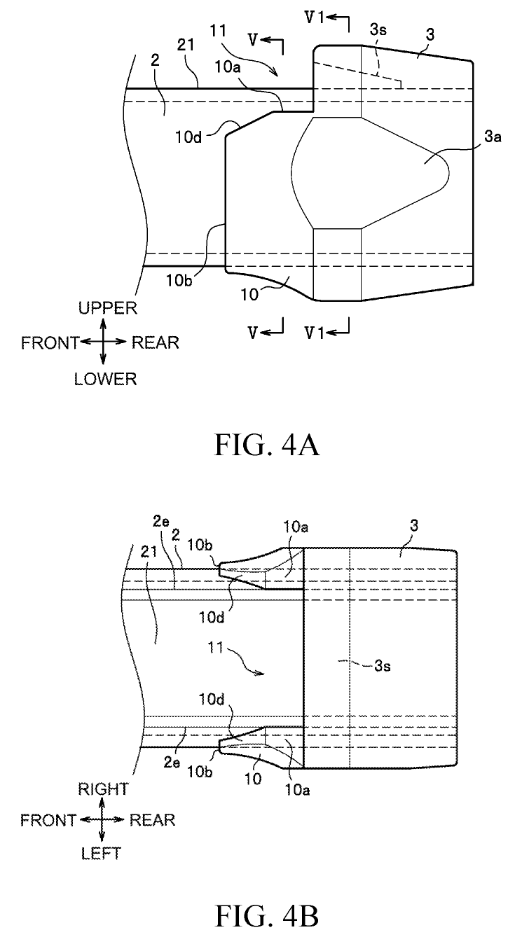

The fixed hood 3 is fixed to a rear end of the reel seat body 2 by a fixing means such as an adhesive, and has a tubular shape. As illustrated in FIG. 4A, the fixed hood 3 is formed with a recess 3s into which a mounting leg portion 52 (see FIG. 6, the same applies hereinafter) on the rear side of the reel is inserted and fixed. An extending portion 10 extending toward the movable hood 4 (see FIG. 2, another side) on the front side is formed in the front portion of the fixed hood 3. The extending portion 10 has a substantially cylindrical shape along the outer surface of the reel seat body 2.

As illustrated in FIGS. 4A and 4B, the extending portion 10 has an outer shape that is reduced in diameter toward the front side, and is inclined in a curved concave shape such that its peripheral surface approaches the outer surface of the reel seat body 2 toward the front side. Note that it is sufficient that the peripheral surface of the extending portion 10 is formed so as to approach the outer surface of the reel seat body 2 toward the front side, and the extending portion 10 may be inclined linearly or in a curved convex shape. In addition, the axial length of the extending portion 10 can be appropriately set. Note that the axial length of the extending portion 10 is preferably set to a length that does not interfere with a clamp member for fixing the reel 50 in the specification for mounting the large reel 50, for example, 13 mm or less.

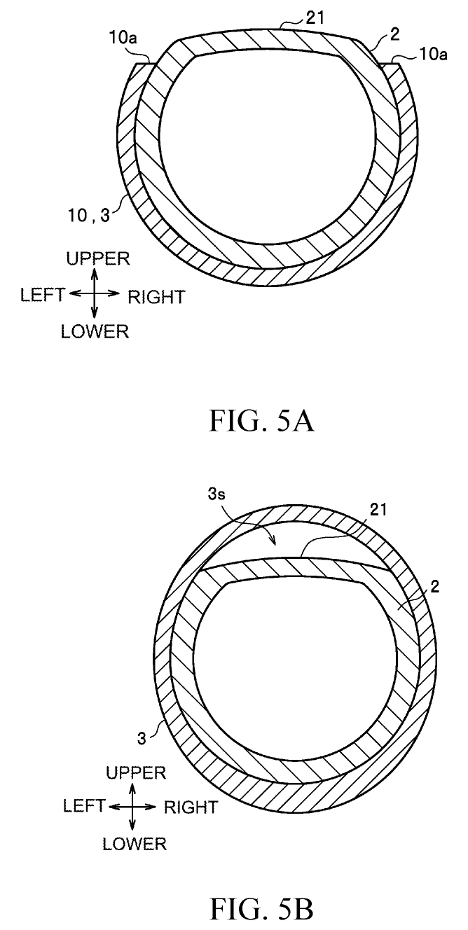

As illustrated in FIGS. 2 and 3, the extending portion 10 comprises a notch portion 11 that is partially notched. The notch portion 11 corresponds to the placement portion 21 of the reel seat body 2, and is formed in the upper portion of the fixed hood 3 such that the placement portion 21 is exposed upward. As illustrated in FIG. 4B, the circumferential ends 10a and 10a of the extending portion 10 that is notched due to the notch portion 11 are disposed in a positional relationship of not interfering so as not to be hooked on the placement portion 21. In other words, the ends 10a and 10a are located below the placement portion 21. That is, as illustrated in FIG. 5A, each end 10a is located at a position away from the placement portion 21 so as not to overlap with the placement portion 21 when viewed from the axial direction of the reel seat body 2. Accordingly, at least a part of the placement portion 21 is not covered with the extending portion 10, and smooth insertion and removal of the mounting leg portion 52 with respect to the recess 3s of the fixed hood 3 is realized. For example, in a case where a horizontal reference plane including a central axis (not illustrated) of the reel seat body 2 is set, the positions of the ends 10a and 10a are preferably located above the horizontal reference plane and below the placement portion 21. Note that in FIGS. 5A and 5B, the step portion 2e of the reel seat body 2 is omitted.

As illustrated in FIG. 4B, the extending portion 10 comprises inclined portions 10d and 10d continuous with the ends 10a and 10a. As illustrated in FIG. 4A, the inclined portion 10d extends obliquely forward and downward from the front end of the end 10a toward a tip 10b. Due to the inclined portion 10d as described above, a shape is made in which the front side portion of the end 10a is obliquely notched, and together with the outer shape of the extending portion 10 that is reduced in diameter toward the front side, the hand feel when gripped is improved. Note that a step between the tip 10b of the extending portion 10 and the outer surface of the reel seat body 2 is preferably set to 1 mm or less.

As illustrated in FIG. 5B, the body portion of the fixed hood 3 bulges downward and has a substantially elliptical cross section. In addition, as illustrated in FIG. 2, a locking surface 3a having a flat shape is formed on a side portion of the fixed hood 3 in order to improve hand feel when gripped.

The movable hood 4 has a tubular shape, and comprises a recess 4s into which a mounting leg portion 51 (see FIG. 6, the same applies hereinafter) on the front side of the reel 50 is inserted and fixed as illustrated in FIGS. 2, 3, and 6. The movable hood 4 is of a down-lock type in which the movable hood 4 moves toward the fixed hood 3 on the rear side. The movable hood 4 is movable alone in the front-rear direction along the step portion 2e of the reel seat body 2. As illustrated in FIG. 2, a locking surface 4a having a flat shape is formed on a side portion of the movable hood 4 in order to improve hand feel when gripped.

The operation member 5 is a ring-shaped member screwed to the male screw portion 2a of the reel seat body 2, and is disposed on the front side of the movable hood 4. The operation member 5 rotates in the circumferential direction to move in the axial direction while rotating in the front-rear direction, and comes into contact with or separates from the movable hood 4. By the contact and separation of the operation member 5, it is possible to tighten the movable hood 4 with respect to the mounting leg portion 51 on the front side or release the tightening.

The nut member 6 is a ring-shaped member screwed to the male screw portion 2a of the reel seat body 2, and is disposed on the front side of the operation member 5. The nut member 6 is a member for preventing loosening that is screwed to the male screw portion 2a and tightened toward the operation member 5 (movable hood 4).

The fixing member 7 is a member fixed to the front end of the reel seat body 2, and has a ring shape. The fixing member 7 is a component for screwing and fixing the connection component 2b to the reel seat body 2 by screwing to the male screw portion 2a.

Next, a procedure for fixing the mounting leg portions 51 and 52 of the reel 50 to the reel seat 1 will be described. First, the mounting leg portion 52 on the rear side of the reel 50 is inserted into the recess 3s of the fixed hood 3. In this case, the rear mounting leg portion 52 can be easily inserted into the recess 3s of the fixed hood 3 through the notch portion 11. That is, when the mounting leg portion 52 on the rear side is inserted, insertion work can be smoothly performed without the extending portion 10 interfering.

In addition, when the mounting leg portion 52 on the rear side is inserted, for example, as illustrated in FIG. 7, even if the movable hood 4 moves toward the fixed hood 3, close contact between the movable hood 4 and the fixed hood 3 is prevented. That is, a rear end 4b of the movable hood 4 abuts on the tip 10b of the extending portion 10, and a gap S corresponding to the length of the extending portion 10 is secured between the movable hood 4 and the fixed hood 3. Accordingly, the movable hood 4 can be moved to the front side while the rear mounting leg portion 52 is inserted and held in the recess 3s through the gap S. That is, when the mounting leg portion 52 on the rear side is inserted, it is not necessary to move the movable hood 4 to the front side in advance.

Thereafter, the movable hood 4 is put on the mounting leg portion 51 on the front side, and the operation member 5 is rotated to tighten the movable hood 4. Then, the nut member 6 is tightened toward the operation member 5, and the operation member 5 is prevented from loosening. As described above, the mounting leg portions 51 and 52 of the reel 50 can be fixed to the reel seat 1, and the reel 50 is mounted on the fishing rod R.

According to the reel seat 1 and the fishing rod R of the present embodiment described above, since the fixed hood 3 comprises the extending portion 10 extending while reducing in diameter toward the front side, the step formed between the reel seat body 2 and the fixed hood 3 is reduced as much as possible, and the hand feel when gripped is improved. Therefore, grip performance can be improved.

In addition, since the extending portion 10 is partially notched due to the notch portion 11, it is possible to reduce the weight while providing the extending portion 10 in a necessary portion. Then, since the notch portion 11 is provided in the portion corresponding to the placement portion 21, it is possible to suitably prevent the mounting leg portion 52 on the rear side from interfering with the extending portion 10 when the reel 50 is attached or detached and after the reel 50 is mounted. Therefore, smooth attachment and detachment of the reel 50 can be realized, and damage to the mounting leg portion 52 and the fixed hood 3 can be prevented.

In addition, since the facing surfaces of the fixed hood 3 and the movable hood 4 do not entirely come into contact with each other due to the presence of the extending portion 10, workability at the time of mounting the reel 50 is improved.

In addition, a step that is likely to be formed between the reel seat body 2 and the fixed hood 3 which are made of metal is reduced as much as possible by the extending portion 10, and the hand feel when gripped is improved.

In addition, since the circumferential ends 10a and 10a of the extending portion 10 are disposed at positions away from the placement portion 21 when viewed from the axial direction of the reel seat body 2, it is possible to reliably avoid the mounting leg portion 52 on the rear side of the reel 50 from interfering with the extending portion 10 when the reel 50 is attached or detached, for example. Therefore, smooth attachment and detachment of the reel 50 can be realized.

In addition, by tightening the nut member 6, the movable hood 4 can be prevented from moving in a loosening direction (returning rotation of the operation member 5), so that the reel 50 can be firmly fixed. Therefore, fishing operability is improved.

### Second Embodiment

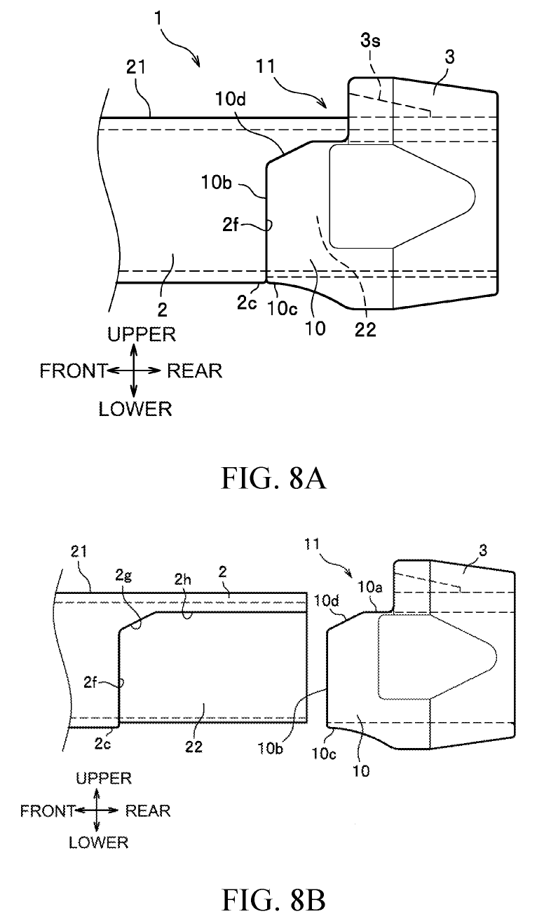

Next, a reel seat of a second embodiment will be described with reference to FIGS. 8A and 8B. The reel seat 1 of the present embodiment is different from that of the first embodiment in that the outer surface of the extending portion 10 of the fixed hood 3 is provided to be continuous to the outer surface of the reel seat body 2 without a step.

As a configuration for this purpose, as illustrated in FIGS. 8A and 8B, a step portion 22 into which the extending portion 10 is fitted is provided in the rear portion of the reel seat body 2 so as to be continuous without a step. The step portion 22 is provided in the circumferential direction of the reel seat body 2 corresponding to the shape of the extending portion 10, and is formed to have a smaller diameter than the outer surface of the reel seat body 2. Since the shape of the step portion 22 is bilaterally symmetrical corresponding to the shape of the extending portion 10, the shape of the step portion 22 viewed from the left side will be described below.

As illustrated in FIG. 8B, an edge portion of the step portion 22 is defined by an upper edge portion 2h, an inclined edge portion 2g, and a front edge portion 2f. The upper edge portion 2h corresponds to the end 10a of the extending portion 10 of the fixed hood 3, and extends in the axial direction toward the front side from the rear end of the reel seat body 2. The inclined edge portion 2g corresponds to the inclined portion 10d of the extending portion 10, and extends obliquely forward and downward from the front end of the upper edge portion 2h toward the front side. The front edge portion 2f corresponds to the tip 10b of the extending portion 10 and extends over the left and right inclined edge portions 2g.

According to the present embodiment, as illustrated in FIG. 8A, when the extending portion 10 is fitted into the step portion 22, an outer surface 10c of the extending portion 10 of the fixed hood 3 is continuous to an outer surface 2c of the reel seat body 2 without a step. That is, there is no step formed between the reel seat body 2 and the fixed hood 3, and the hand feel when gripped is further improved. Therefore, the grip performance is further improved.

### Third Embodiment

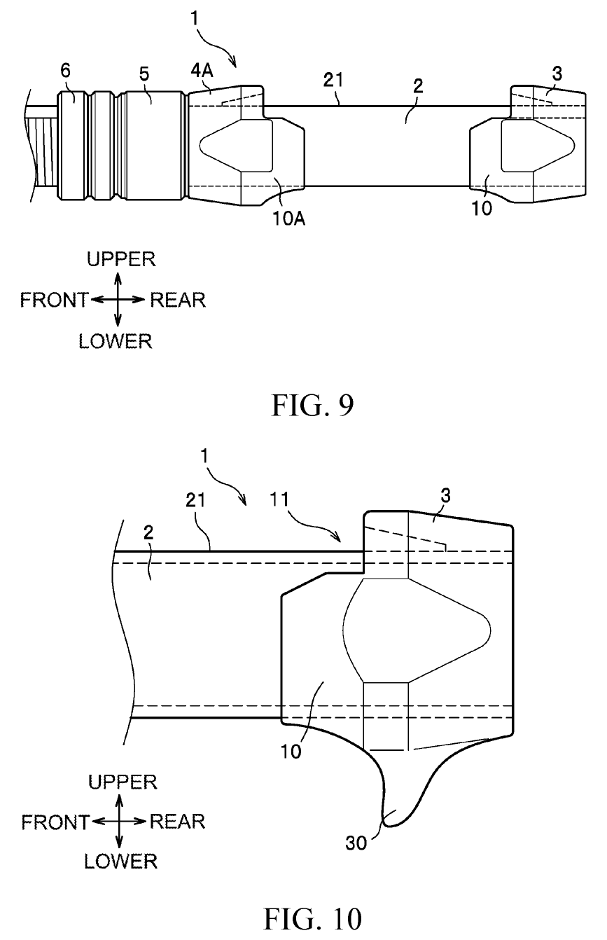

Next, a reel seat of a third embodiment will be described with reference to FIG. 9. The reel seat 1 of the present embodiment is different from those of the first and second embodiments in that an extending portion 10A is also provided on a movable hood 4A side.

As illustrated in FIG. 9, the extending portion 10A is provided at the rear portion of the movable hood 4A and extends toward the fixed hood 3 on the rear side. The extending portion 10A has a substantially cylindrical shape along the outer surface of the reel seat body 2. The extending portion 10A has an outer shape that is reduced in diameter toward the rear side, and is inclined in a curved concave shape such that its peripheral surface approaches the outer surface of the reel seat body 2 toward the rear side. Note that it is sufficient that the peripheral surface of the extending portion 10A is formed so as to approach the outer surface of the reel seat body 2 toward the rear side, and the extending portion 10A may be inclined linearly or in a curved convex shape.

According to the present embodiment, since the extending portion 10A is also provided on the movable hood 4A side, a step formed between the reel seat body 2 and the movable hood 4A is reduced as much as possible, and the hand feel when gripped is further improved. Note that the extending portion 10 of the fixed hood 3 is not necessarily provided, but when provided, a synergistic effect with the extending portion 10A of the movable hood 4A is enhanced, and the gripping performance is further improved.

### Fourth Embodiment

Next, a reel seat of a fourth embodiment will be described with reference to FIG. 10. The reel seat 1 of the present embodiment is different from those of the first to third embodiments in that a trigger 30 is integrally provided in the lower portion of the fixed hood 3.

As illustrated in FIG. 10, the trigger 30 is formed in the lower portion of the fixed hood 3 so as to protrude downward continuously with the outer surface of the extending portion 10. The trigger 30 is a part for holding a finger of the angler.

According to the present embodiment, since the trigger 30 is provided in the fixed hood 3, it is easy to grip, and the grip performance is improved. In addition, since the trigger 30 is formed continuously with the extending portion 10, natural gripping is possible from the reel seat body 2 via the extending portion 10 to the trigger 30, and the hand feel is improved. Therefore, an operability in fishing is improved.

Although the embodiments have been described above, the present invention is not limited to the examples described in the embodiments. For example, in the embodiment described above, the movable hood 4 has been described to have a down-lock specification in which the movable hood 4 moves toward the fixed hood 3 on the rear side, but the present invention is not limited thereto, and the movable hood 4 may have an up-lock specification in which the fixed hood 3 is disposed on the front side, the movable hood 4 is disposed on the rear side, and the movable hood 4 moves toward the fixed hood 3 on the front side.

In addition, the notch portion 11 is formed so as to correspond to the placement portion 21 of the reel seat body 2, but is not limited thereto, and may be additionally provided at another portion in the circumferential direction of the extending portion 10. In this case, the notch portion 11 can also be used as a finger hooking portion for a finger when gripped.

In addition, although the ends 10a and 10a of the extending portion 10 are disposed at positions away from the placement portion 21 so as not to overlap with the placement portion 21, the present invention is not limited thereto, and the ends may be provided so as to partially cover the placement portion 21 within a range not interfering with attachment and detachment of the mounting leg portion 52.

In addition, the nut member 6 is not necessarily provided.

### REFERENCE SIGNS LIST

1 Reel seat

2 Reel seat body

2a Male screw portion

3 Fixed hood

4 Movable hood

6 Nut member

10 Extending portion

10a End

11 Notch portion

21 Placement portion

50 Reel

51, 52 Mounting leg portion

What is claimed is:

1. A reel seat comprising: a reel seat body having a placement portion on which a mounting leg portion of a reel is placed; and a fixed hood and a movable hood each of which has a tubular shape and is provided so as to face the reel seat body, wherein
at least one of the fixed hood or the movable hood is formed with an extending portion extending while reducing in diameter toward the other, and
the extending portion comprises a notch portion that is partially notched.

2. The reel seat according to claim 1, wherein the reel seat body, the fixed hood, and the movable hood are made of metal.

3. The reel seat according to claim 1, wherein in the extending portion, a portion corresponding to the placement portion is notched due to the notch portion.

4. The reel seat according to claim 3, wherein a circumferential end of the extending portion notched due to the notch portion is disposed at a position away from the placement portion when viewed from an axial direction of the reel seat body.

5. The reel seat according to claim 1, wherein
the reel seat body comprises a male screw portion, and
the reel seat comprises a nut member for preventing loosening that is screwed to the male screw portion and tightened toward the movable hood.

6. A fishing rod comprising the reel seat according to claim 1.
